(19) United States
(12) Patent Application Publication
(10) Pub. No.: US 2025/0253561 A1
(43) Pub. Date: Aug. 7, 2025

(54) ELECTRICAL CONNECTOR AND CONNECTOR ASSEMBLY

(71) Applicant: HIROSE ELECTRIC CO., LTD., Kanagawa (JP)

(72) Inventor: Kouhei ODA, Kanagawa (JP)

(21) Appl. No.: 19/027,218

(22) Filed: Jan. 17, 2025

(30) Foreign Application Priority Data
Feb. 5, 2024 (JP) 2024-015525

(51) Int. Cl. H01R 12/71; H01R 13/502

(52) U.S. Cl. CPC H01R 12/716; H01R 13/502

(57) ABSTRACT

Provided is an electrical connector that includes: a housing; a plurality of terminals: and a through-hole, in which the housing has a rectangular shape in plan view, and includes four wall portions extending along four sides of the rectangular shape respectively, the plurality of terminals is held by all the four wall portions, the through-hole is provided in a portion surrounded by the four wall portions of the housing in such a manner as to extend in a direction of mating to a mating connector, each of the plurality of terminals includes a mounting portion configured to be mounted on a mounted object, and the mounting portions of a part of the plurality of terminals is placed on a through-hole side.

### CROSS-REFERENCE TO RELATED APPLICATION

This application claims priority from Japanese Patent Application No. 2024-015525 filed with the Japan Patent Office on Feb. 5, 2024, the entire content of which is hereby incorporated by reference.

### BACKGROUND

### 1. Technical Field

The present disclosure relates to an electrical connector and a connector assembly.

### 2. Related Art

Various technologies are known which are related to an electrical connector that includes terminals and a housing and is configured to connect, for example, a printed wiring board or a flexible flat cable. For example, JP-A-2002-75491 discloses an electrical connector including: a housing having a rectangular shape in plan view; and a plurality of terminals placed along all sides of the rectangular shape of the housing. Similar electrical connectors are disclosed in, for example, JP-A-2010-123468 and JP-A-2019-139938.

### SUMMARY

An electrical connector according to an embodiment of the present disclosure includes: a housing; a plurality of terminals: and a through-hole, in which the housing has a rectangular shape in plan view, and includes four wall portions extending along four sides of the rectangular shape respectively, the plurality of terminals is held by all the four wall portions, the through-hole is provided in a portion surrounded by the four wall portions of the housing in such a manner as to extend in a direction of mating to a mating connector, each of the plurality of terminals includes a mounting portion configured to be mounted on a mounted object, and the mounting portions of a part of the plurality of terminals is placed on a through-hole side.

### BRIEF DESCRIPTION OF THE DRAWINGS

FIG. 1 is a perspective view of a connector assembly according to a first embodiment of the present disclosure;

FIGS. 2A and 2B are plan views of a receptacle connector according to the first embodiment of the present disclosure as viewed from above and below respectively;

FIG. 3 is a perspective view of, for example, terminals of the receptacle connector according to the first embodiment of the present disclosure;

FIGS. 4A and 4B are perspective views of a part of the terminals of the receptacle connector according to the first embodiment of the present disclosure;

FIGS. 5A and 5B are plan views of a plug connector according to the first embodiment of the present disclosure as viewed from above and below respectively;

FIG. 6 is a perspective views of, for example, terminals of the plug connector according to the first embodiment of the present disclosure;

FIGS. 7A and 7B are perspective views of a part of the terminals of the plug connector according to the first embodiment of the present disclosure;

FIG. 8 is a side view of the connector assembly according to the first embodiment of the present disclosure;

FIG. 9 is a cross-sectional view of the connector assembly according to the first embodiment of the present disclosure as viewed along line IX-IX of FIG. 8;

FIG. 10 is a perspective view of a connector assembly according to a second embodiment of the present disclosure;

FIGS. 11A and 11B are plan views of a receptacle connector according to the second embodiment of the present disclosure as viewed from above and below respectively;

FIGS. 12A and 12B are plan views of a plug connector according to the second embodiment of the present disclosure as viewed from above and below respectively;

FIG. 13 is a side view of the connector assembly according to the second embodiment of the present disclosure; and

FIG. 14 is a cross-sectional view of the connector assembly according to the second embodiment of the present disclosure as viewed along line XIV-XIV of FIG. 13.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In JP-A-2002-75491, JP-A-2010-123468, and JP-A-2019-139938, which are described above, the plurality of terminals is placed on all the sides of the rectangular housing to reduce the footprint of the electrical connector and increase the number of contacts of the terminals. The footprint of the electrical connector corresponds to the area occupied by the electrical connector on, for example, a relevant board, that is, the area of the electrical connector as viewed in plan view. However, in the technologies described in JP-A-2002-75491, JP-A-2010-123468, and JP-A-2019-139938, mounting portions of all the terminals are placed, facing outward of the electrical connector and therefore there is room for improvement in an increase in the number of contacts of the terminals.

One of objects of the present disclosure is to reduce the footprint of an electrical connector and increase the number of contacts of terminals.

An electrical connector according to one embodiment of the present disclosure includes: a housing; a plurality of terminals: and a through-hole, in which the housing has a rectangular shape in plan view, and includes four wall portions extending along four sides of the rectangular shape respectively, the plurality of terminals is held by all the four wall portions, the through-hole is provided in a portion surrounded by the four wall portions of the housing in such a manner as to extend in a direction of mating to a mating connector, each of the plurality of terminals includes a mounting portion configured to be mounted on a mounted object, and the mounting portions of a part of the plurality of terminals is placed on a through-hole side.

According to the present disclosure, it is possible to reduce the footprint of an electrical connector and increase the number of contacts of terminals.

Embodiments of the present disclosure are described hereinafter with reference to the drawings. Note that the same reference numerals are assigned to the same members in principle in all the drawings for describing the embodiments, and repetitive descriptions thereof may be omitted.

### FIRST EMBODIMENT

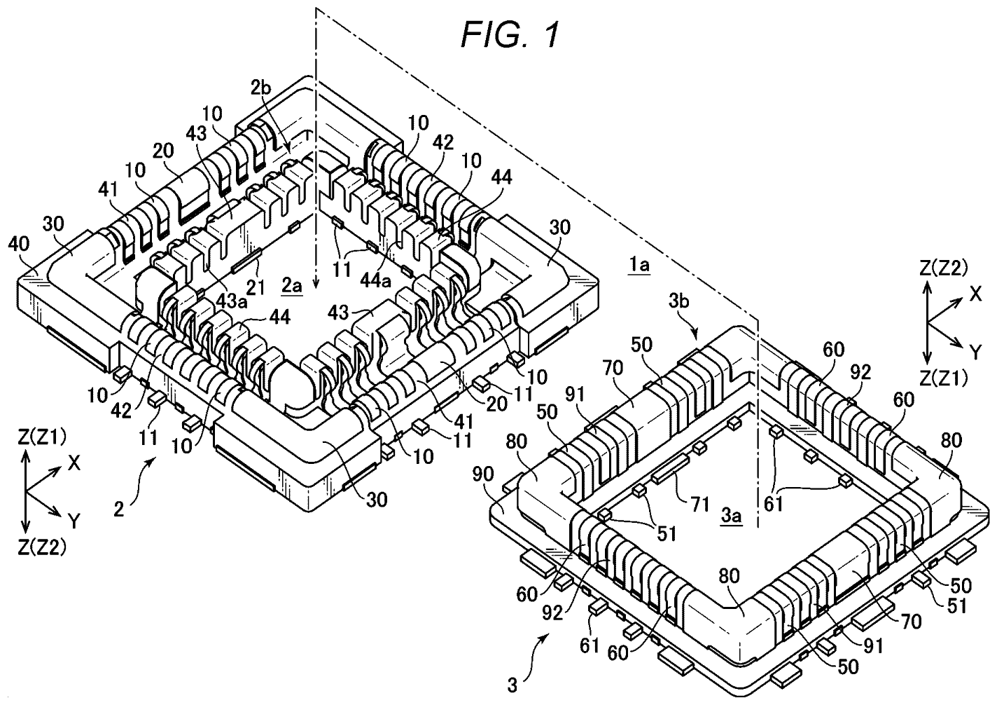

Firstly, the configuration of a connector assembly according to a first embodiment of the present disclosure is described with reference to FIG. 1. FIG. 1 is a perspective view of the connector assembly according to the first embodiment in an unmated state.

As illustrated in FIG. 1, a connector assembly 1a according to the first embodiment includes a receptacle connector 2 and a plug connector 3, and is configured in such a manner that the receptacle connector 2 and the plug connector 3 are mated together.

When the receptacle connector 2 and the plug connector 3 are not distinguished below, they may be denoted as the “connectors 2 and 3.” The connectors 2 and 3 are mounted on boards (not illustrated) such as printed wiring boards as mounted objects that are electrically connected together.

FIG. 1 illustrates the connectors 2 and 3 both in a state where a mating side (mating surface) is placed on the front side and a side to be mounted on the board is placed on the back side. Moreover, the connectors 2 and 3 can be used as internal components of small electronic apparatuses such as mobile phones, smartphones, digital cameras, and notebook computers. Note that the connectors 2 and 3 are examples of the “electrical connector” of the present disclosure. These connectors 2 and 3 can be mounted on various mounted objects such as flexible flat cables, other than the above boards. However, an example where the connectors 2 and 3 are mounted on the boards is cited below.

In FIG. 1 (the same applies to the other drawings), “Z” denotes a mating direction of the connectors 2 and 3 (an up-and-down direction), “X” denotes one direction of the connectors 2 and 3 that is orthogonal to the mating direction Z (referred to below as the “horizontal direction”), and “Y” denotes the other direction of the connectors 2 and 3 that is orthogonal to the mating direction Z (referred to below as the “vertical direction”). In other words, an axis along the horizontal direction is defined as the X-axis, an axis along the vertical direction is defined as the Y-axis, and an axis along the mating direction is defined as the Z-axis. Moreover, in the specification, in terms of a certain connector, in the mating direction Z, a side that receives a mating connector is defined as “up” or “front”, and a side that is attached to the board is defined as “down” or “back”. Specifically, in the receptacle connector 2, a direction indicated with “Z1” in the mating direction Z corresponds to “upward”, and a direction indicated with “Z2” in the mating direction Z corresponds to “downward”. On the other hand, in the plug connector 3, the direction indicated with “Z2” corresponds to “upward”, and the direction indicated with “Z1” corresponds to “downward”. Note that FIG. 1 illustrates a state where the plug connector 3 has been turned backside front from a state of being mated to the receptacle connector 2 for convenience of description.

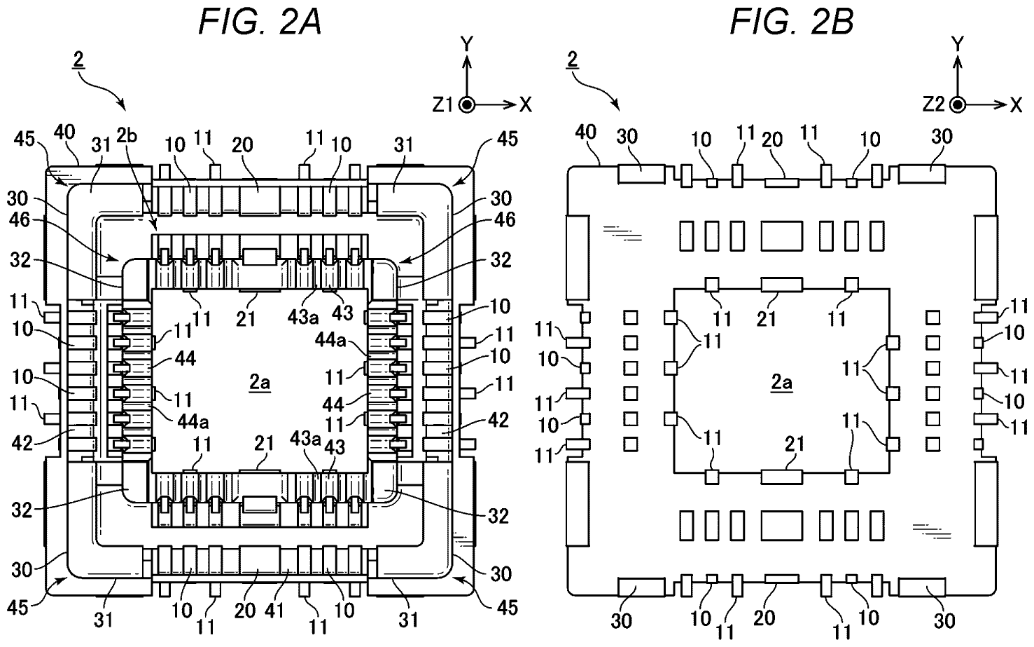

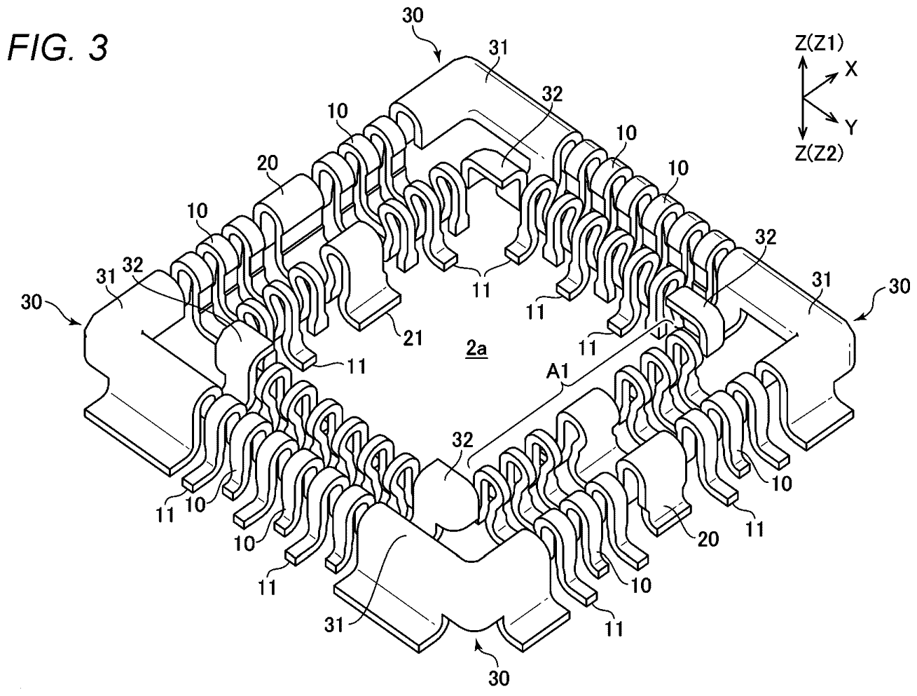

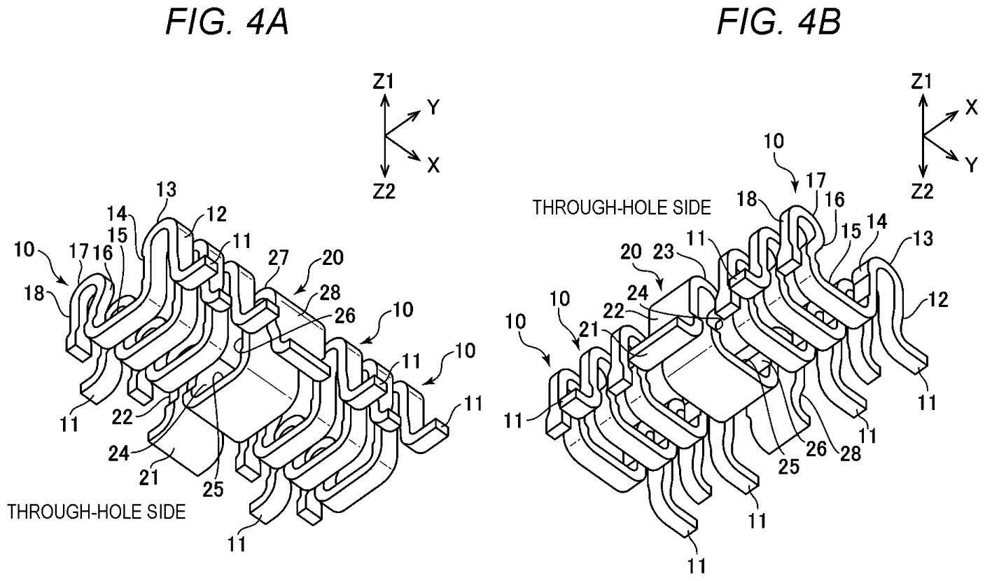

Next, the receptacle connector 2 according to the first embodiment is described also with reference to FIGS. 2A to 4B in addition to FIG. 1. FIG. 2A is a plan view of the receptacle connector 2 as viewed from above (the front). FIG. 2B is a plan view of the receptacle connector 2 as viewed from below (the back). FIG. 3 is a perspective view of, for example, terminals (metal portions with a housing removed) of the receptacle connector 2. FIGS. 4A and 4B are perspective views of a part (a portion indicated with a reference numeral A1 of FIG. 3) of the terminals of the receptacle connector 2 as viewed in different directions respectively.

As illustrated in FIGS. 1, 2A and 2B, the receptacle connector 2 has a rectangular shape close to a square in plan view. The receptacle connector 2 mainly includes a plurality of terminals 10 as signal terminals, two terminals 20 as power terminals, reinforcing metal fittings 30, and a housing 40 that holds the terminals 10 and 20 and the reinforcing metal fittings 30. The terminals 10 and 20 and the reinforcing metal fittings 30 are formed of a conductive member such as a copper alloy, and the housing 40 is formed of resin such as liquid crystal polymer (LCP). The receptacle connector 2 is created by, for example, integral molding (typically insert molding), using such materials.

The housing 40 of the receptacle connector 2 has a rectangular shape in plan view, and includes four wall portions extending along four sides of the rectangular shape respectively. The four wall portions of the housing 40 include a pair of wall portions each having a first outer wall portion 41 and a second outer wall portion 42, and a pair of wall portions each having a first inner wall portion 43 and a second inner wall portion 44. The first inner wall portions 43 are provided inward of the first outer wall portions 41, and the second inner wall portion 44 are provided inward of the second outer wall portions 42.

In other words, the housing 40 includes a pair of the first outer wall portions 41 that extends in the horizontal direction X, and is spaced apart in such a manner as to face each other in the vertical direction Y, a pair of the second outer wall portions 42 that extends in the vertical direction Y and is spaced apart in such a manner as to face each other in the horizontal direction X, a pair of the first inner wall portions 43 that is provided inward of the first outer wall portions 41, extends in the horizontal direction X, and is spaced apart in such a manner as to face each other in the vertical direction Y, and a pair of the second inner wall portions 44 that is provided inward of the second outer wall portions 42, extends in the vertical direction Y, and is spaced apart in such a manner as to face each other in the horizontal direction X.

Moreover, the housing 40 includes four corner portions 45 where end portions of the pair of the first outer wall portions 41 and the pair of the second outer wall portions 42 are coupled, and four corner portions 46 where end portions of the pair of the first inner wall portions 43 and the pair of the second inner wall portions 44 are coupled (FIG. 2A). Note that the corner portions 45 and 46 are covered with the reinforcing metal fittings 30 and therefore are not visible in, for example, FIG. 2A.

The receptacle connector 2 according to the embodiment is formed in a central portion thereof with a single through-hole 2a extending in the mating direction Z. The through-hole 2a is provided in a portion surrounded by the pair of the first inner wall portions 43 and the pair of the second inner wall portions 44 of the housing 40. The through-hole 2a has a rectangular shape in plan view. For example, a board component (for example, a chip capacitor) can be placed in the portion where the through-hole 2a of the receptacle connector 2 is.

The terminals 10 of the receptacle connector 2 are provided in groups along all the four sides of the rectangular housing 40. Specifically, the receptacle connector 2 includes groups of the terminals 10 that are held by the first outer wall portions 41 and the first inner wall portions 43 and extend in the vertical direction Y, and groups of the terminals 10 that are held by the second outer wall portions 42 and the second inner wall portions 44 and extend in the horizontal direction X.

The terminals 10 that are held by the first outer wall portions 41 and the first inner wall portions 43 and extend in the vertical direction Y are held at their one ends by the first outer wall portions 41, and at their other ends by the first inner wall portions 43. The group of the terminals 10 held by one of a pair of the wall portions each having the first outer wall portion 41 and the first inner wall portion 43 and the group of the terminals 10 held by the other of the pair face each other in the vertical direction Y and are symmetrically placed.

The terminals 10 that are held by the second outer wall portions 42 and the second inner wall portions 44 and extend in the horizontal direction X are held at their one ends by the second outer wall portions 42, and at their other ends by the second inner wall portions 44. The pair of the terminals 10 held by one of a pair of the wall portions each having the second outer wall portion 42 and the second inner wall portion 44 and the pair of the terminals 10 held by the other of the pair face each other in the horizontal direction X, and are placed in such a manner that mounting portions 11 face in the same direction (either of one or the other direction in the horizontal direction 10).

Moreover, these terminals 10 each includes the mounting portion 11 for mounting the receptacle connector 2 on the board by soldering. In the embodiment, the mounting portions 11 of a part of the groups of the terminals 10 are placed on a through-hole 2a side, and the mounting portions 11 of the rest of the groups of the terminals 10 are placed on a side opposite to the through-hole 2a (that is, placed in such a manner as to face outward of the receptacle connector 2). Specifically, the mounting portions 11 of adjacent terminals 10 of each of the groups of the terminals 10 arranged in a row along the horizontal direction X or the vertical direction Y are located alternately on the through-hole 2a side and on the side opposite to the through-hole 2a (FIGS. 2A, 2B, 3, 4A, and 4B).

In the receptacle connector 2, end portions on the through-hole 2a side of the groups of the terminals 10 are held by the first inner wall portions 43 and the second inner side wall portions 44 of the housing 40. The first inner wall portions 43 and the second inner wall portions 44 are formed with slit portions 43a and slit portions 44a, which extend in the mating direction Z, between the adjacent terminals 10, respectively. Consequently, the end portions of the terminals 10 held by the first inner wall portions 43 and the second inner wall portions 44 are designed to be elastically deformable toward the through-hole 2a.

Moreover, the receptacle connector 2 includes an approximately rectangular ring-shaped mating recessed portion 2b recessed in the mating direction Z. The mating recessed portion 2b is formed in portions between the first outer wall portions 41 and the first inner wall portions 43, which include the groups of the terminals 10, and portions between the second outer wall portions 42 and the second inner wall portions 44, which include the groups of the terminals 10. The plug connector 3 is formed with an approximately rectangular ring-shaped mating protruding portion 3b protruding in the mating direction Z. It is configured in such a manner that the mating protruding portion 3b of the plug connector 3 fits into the mating recessed portion 2b of the receptable connector 2 (FIG. 1).

Furthermore, the receptacle connector 2 is provided with the pair of terminals 20 as the power terminals. The pair of terminals 20 is provided in central portions of the pair of the first outer wall portions 41 and the pair of the first inner wall portions 43, which extend in the horizontal direction X, of the housing 40. Each of the terminals 20 is provided between the above terminals 10, and extends in the vertical direction Y. One end of the each of the terminals 20 is held by the first outer wall portion 41, and the other end of the each of the terminals 20 is held by the first inner wall portion 43. The length of the terminals 20 in the vertical direction Y is equal to the length of the terminals 10 in the vertical direction Y, and the length of the terminals 20 in the horizontal direction X is greater than the length of the terminals 10 in the horizontal direction X. The each of the terminals 20 also includes a mounting portion 21, and the mounting portions 21 are placed on the through-hole 2a side. Note that the terminals 20 are not limited to being configured as the power terminals, and may be configured as ground terminals.

In other words, the receptacle connector 2 includes the terminals 10 as the signal terminals, and the terminals 20 as at least either the power terminals or the ground terminals.

Furthermore, the receptacle connector 2 is provided with the reinforcing metal fittings 30. The reinforcing metal fittings 30 are provided to the four corner portions 45 and the four corner portions 46 of the housing 40 in such a manner as to cover the corner portions 45 and the corner portions 46 (FIG. 2A). The reinforcing metal fittings 30 are each formed by coupling an L-shaped reinforcing portion 31 that is formed in such a manner as to cover the relatively large corner portion 45, and a reinforcing portion 32 that is formed in such a manner as to cover the corner portion 46 smaller than the corner portion 45 (FIG. 3).

As illustrated in FIGS. 4A and 4B, each of the terminals 10 of the receptacle connector 2 includes leg portions 12, 14, 16, and 18, the mounting portion 11, and coupling portions 13, 15, and 17. The leg portions 12, 14, 16, and 18 extend in the mating direction Z, and are provided in this order along the horizontal direction X, spaced apart from one another. The mounting portion 11 is connected to one end of the leg portion 12.

The coupling portion 13 extends in the horizontal direction X, and connects an end portion of the leg portion 12 and an end portion of the leg portion 14. The coupling portion 15 extends in the horizontal direction X, and connects an end portion of the leg portion 14 and an end portion of the leg portion 16. The coupling portion 17 extends in the horizontal direction X, and connects an end portion of the leg portion 16 and an end portion of the leg portion 18.

Similarly, each of the terminals 20 also includes leg portions 22, 24, 26, and 28, the mounting portion 21, a coupling portion 23, a coupling portion 25, and a coupling portion 27. The leg portions 22, 24, 26, and 28 extend in the mating direction Z, and are provided in this order along the horizontal direction X, spaced apart from one another. The mounting portion 21 is connected to one end of the leg portion 22.

The coupling portion 23 extends in the horizontal direction X, and connects an end portion of the leg portion 22 and an end portion of the leg portion 24. The coupling portion 25 extends in the horizontal direction X, and connects an end portion of the leg portion 24 and an end portion of the leg portion 26. The coupling portion 27 extends in the horizontal direction X, and connects an end portion of the leg portion 26 and an end portion of the leg portion 28.

Note that if the receptacle connector 2 includes four wall portions as described above, the configuration of the receptacle connector 2 translates to: the housing 40 having a rectangular shape in plan view includes four wall portions extending along four sides of the rectangular shape respectively, the plurality of terminals 10 is held by all the four wall portions, and the through-hole 2a is formed in a portion surrounded by the four wall portions of the housing 40.

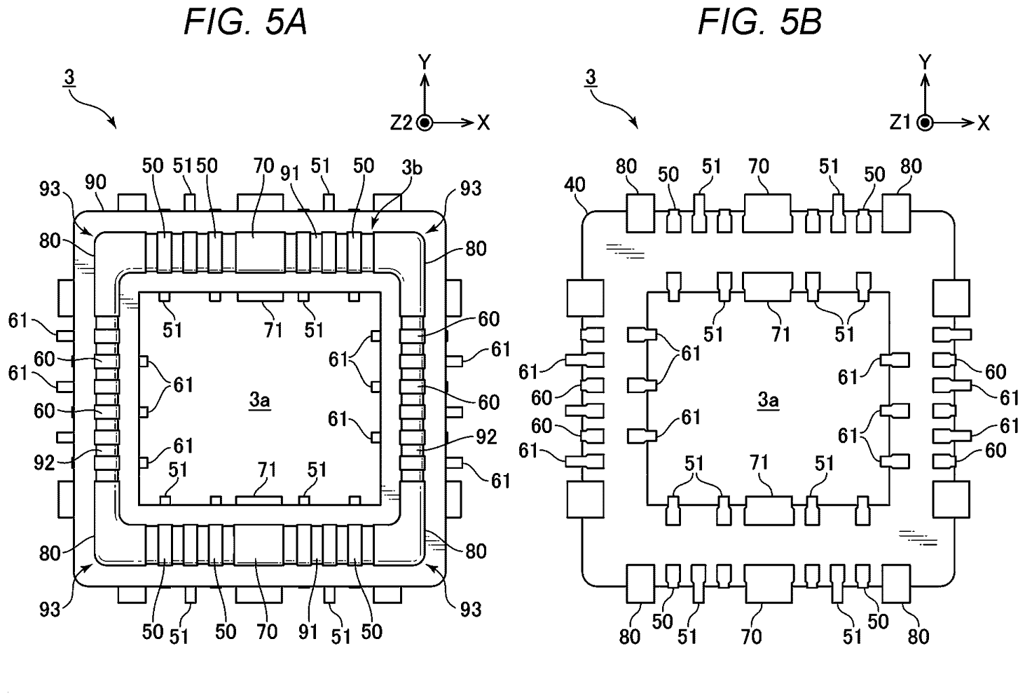

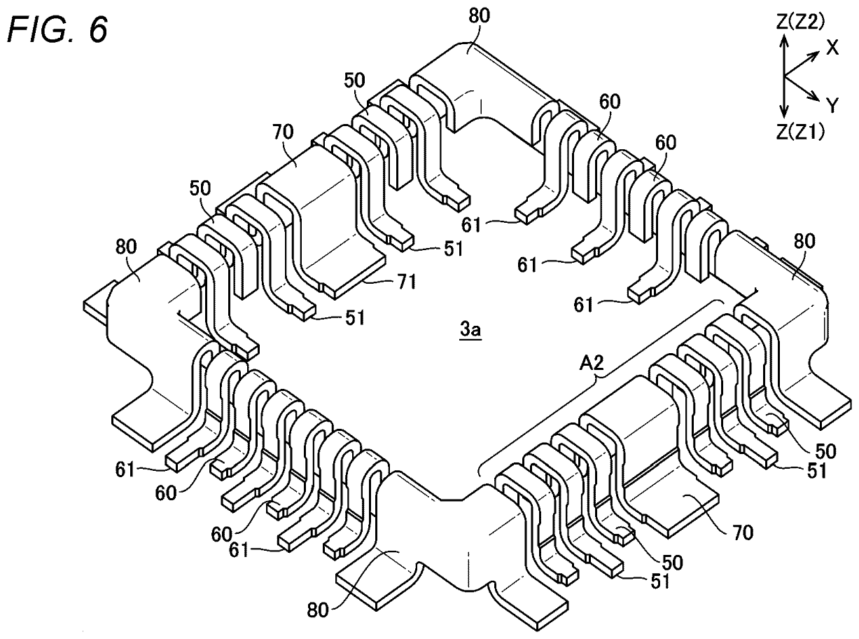

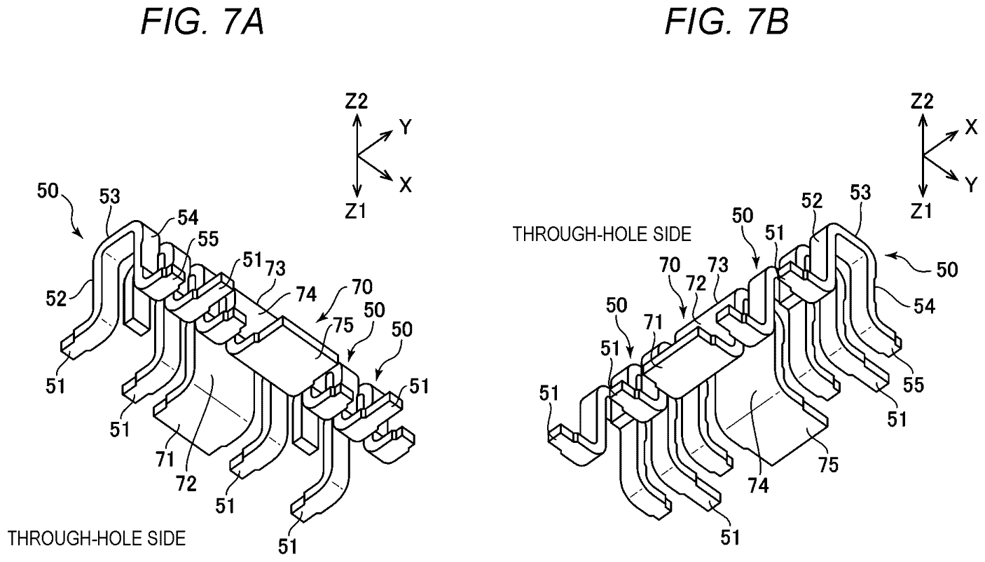

Next, the plug connector 3 according to the first embodiment is described also with reference to FIGS. 5A to 7B in addition to FIG. 1. FIG. 5A is a plan view of the plug connector 3 as viewed from above (the front), and FIG. 5B is a plan view of the plug connector 3 as viewed from below (the back). FIG. 6 is a perspective view of, for example, terminals (metal portions with a housing removed) of the plug connector 3. FIGS. 7A and 7B are perspective views of a part (a portion indicated with a reference numeral A2 of FIG. 6) of the terminals of the plug connector 3 as viewed in different directions.

As illustrated in FIGS. 1, 5A, and 5B, the plug connector 3 has a rectangular shape close to a square in plan view. The plug connector 3 mainly includes a plurality of terminals 50 and 60 as signal terminals, two terminals 70 as power terminals, reinforcing metal fittings 80, and a housing 90 that holds the terminals 50, 60, and 70 and the reinforcing metal fittings 80. The terminals 50, 60, and 70 and the reinforcing metal fittings 80 are formed of a conductive member such as a copper alloy, and the housing 90 is formed of resin such as liquid crystal polymer (LCP). The plug connector 3 is created by, for example, integral molding (typically insert molding), using such materials.

The housing 90 of the plug connector 3 has a rectangular shape in plan view, and includes four wall portions extending along four sides of the rectangular shape respectively. The four wall portions of the housing 90 include a pair of first wall portions 91 and a pair of second wall portions 92.

In other words, the housing 90 includes the pair of first wall portions 91 that extends in the horizontal direction X and is spaced apart in such a manner as to face each other in the vertical direction Y, and the pair of second wall portions 92 that extends in the vertical direction Y and is spaced apart in such a manner as to face each other in the horizontal direction X. The length (width) of the first wall portions 91 along the vertical direction Y is greater than the length (width) of the second wall portions 92 along the horizontal direction X.

Moreover, the housing 90 includes four corner portions 93 where end portions of the pair of first wall portions 91 and the pair of second wall portions 92 are coupled (FIG. 5A). Note that the corner portions 93 are covered with the reinforcing metal fittings 80 and therefore are not visible in, for example, FIG. 5A.

The plug connector 3 according to the embodiment is formed in a central portion thereof with a single through-hole 3a extending in the mating direction Z. The through-hole 3a is provided in a portion surrounded by the pair of first wall portions 91 and the pair of second wall portions 92 of the housing 90. The through-hole 3a has a rectangular shape in plan view. For example, a board component (for example, a chip capacitor) can be placed in the portion where the through-hole 3a of the plug connector 3 is.

The terminals 50 and 60 of the plug connector 3 are provided in groups along all the four sides of the rectangular housing 90. Specifically, the plug connector 3 includes groups of the terminals 50 that are held by the first wall portions 91 and extend in the vertical direction Y, and groups of the terminals 60 that are held by the second wall portions 92 and extend in the horizontal direction X.

The group of the terminals 50 held by one of the pair of first wall portions 91 and the group of the terminals 50 held by the other of the pair face each other in the vertical direction Y and are symmetrically placed.

The pair of the terminals 60 held by one of the pair of second wall portions 92 and the pair of the terminals 60 held by the other of the pair face each other in the horizontal direction X, and are placed in such a manner that mounting portions 61 face in the same direction (either of one or the other direction in the horizontal direction 10).

The terminals 50 and 60 have outer shapes similar (analogous) to each other. However, the length of the terminals 50 along the vertical direction Y is greater than the length of the terminals 60 along the horizontal direction X.

Moreover, each of the terminals 50 and each of the terminals 60 include a mounting portion 51 and the mounting portion 61 for mounting the plug connector 3 on the board by soldering, respectively. In the embodiment, the mounting portions 51 and 61 of parts of the groups of the terminals 50 and 60 are placed on a through-hole 3a side, and the mounting portions 51 and 61 of the rests of the groups of the terminals 50 and 60 are placed on a side opposite to the through-hole 3a (that is, placed in such a manner as to face outward of the plug connector 3). Specifically, the mounting portions 51 of adjacent terminals 50 of each of the groups of the terminals 50 arranged in a row along the horizontal direction X are located alternately on the through-hole 3a side and on the side opposite to the through-hole 3a. Moreover, the mounting portions 61 of adjacent terminals 60 of each of the groups of the terminals 60 arranged in a row along the vertical direction Y are located alternately on the through-hole 3a side and on the side opposite to the through-hole 3a (FIGS. 5A, 5B, 6, 7A, and 7B).

Furthermore, the plug connector 3 is provided with the pair of terminals 70 as the power terminals. The pair of terminals 70 is provided in central portions of the pair of first wall portions 91, which extends in the horizontal direction X, of the housing 90. Each of the terminals 70 is provided between the above terminals 50, extends in the vertical direction Y, and is held by the first wall portion 91. The length of the terminals 70 in the vertical direction Y is equal to the length of the terminals 50 in the vertical direction Y, and the length of the terminals 70 in the horizontal direction X is greater than the length of the terminals 50 in the horizontal direction X. The each of the terminals 70 also includes a mounting portion 71, and the mounting portions 71 are placed on the through-hole 3a side. Note that the terminals 70 are not limited to being configured as the power terminals, and may be configured as ground terminals.

Furthermore, the plug connector 3 is provided with the L-shaped reinforcing metal fittings 80. The reinforcing metal fittings 80 are formed at the four corners 93 of the housing 90 in such a manner as to cover the corner portions 93 (FIGS. 5A and 6).

As illustrated in FIGS. 7A and 7B, each of the terminals 50 of the plug connector 3 includes leg portions 52 and 54, the mounting portion 51, a coupling portion 53, and an extension portion 55. The leg portions 52 and 54 extend in the mating direction Z, and are provided along the vertical direction Y, spaced apart from each other. The mounting portion 51 is connected to one end of the leg portion 52. The coupling portion 53 extends in the vertical direction Y, and connects an end portion of the leg portion 52 and an end portion of the leg portion 54. The extension portion 55 is connected to one end of the leg portion 54.

Similarly, each of the terminals 70 includes leg portions 72 and 74, the mounting portion 71, a coupling portion 73, and an extension portion 75. The leg portions 72 and 74 extend in the mating direction Z, and are provided along the vertical direction Y, spaced apart from each other. The mounting portion 71 is connected to one end of the leg portion 72. The coupling portion 73 extends in the vertical direction Y, and connects an end portion of the leg portion 72 and an end portion of the leg portion 74. The extension portion 75 is connected to one end of the leg portion 74. Note that the terminals 60 also have a configuration similar to that of the terminals 50

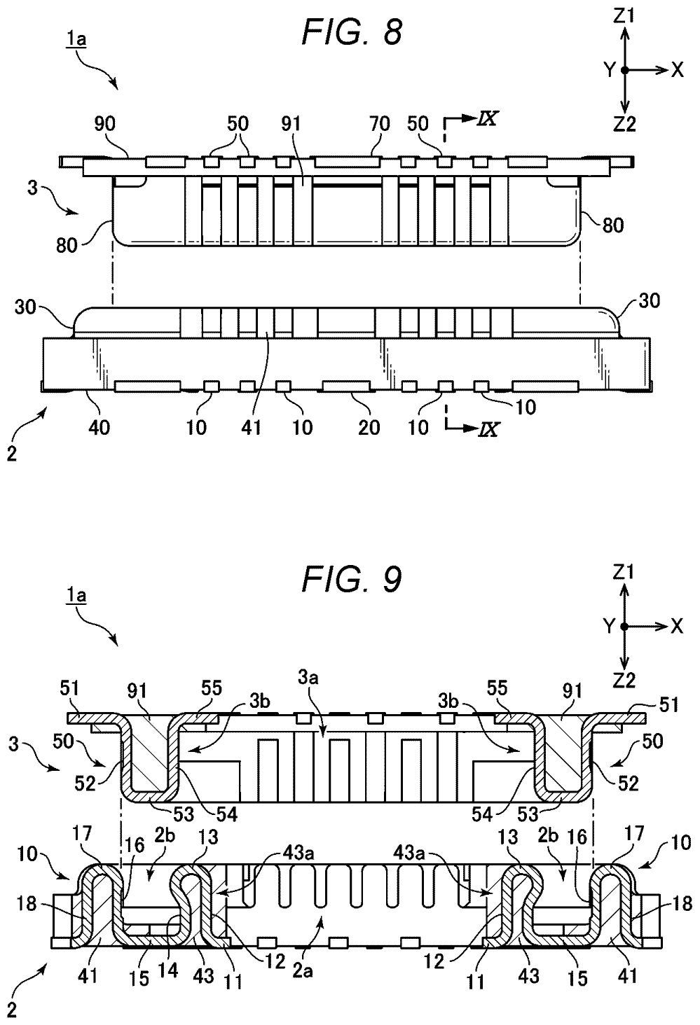

Next, the configurations of the terminals of the receptacle connector 2 and the plug connector 3 according to the first embodiment are described with reference to FIGS. 8 and 9. FIG. 8 is a side view of the connector assembly 1a according to the first embodiment before mating as viewed along the vertical direction Y. FIG. 9 is a cross-sectional view of the connector assembly 1a according to the first embodiment as viewed along line IX-IX of FIG. 8.

Note that a description is given, taking, as an example, the configurations of the terminals 10, which are arranged along the horizontal direction X (which are held by the first outer wall portion 41 and the first inner wall portion 43), of the receptacle connector 2, and the terminals 50, which are arranged along the horizontal direction X (which are held by the first wall portion 91), of the plug connector 3. However, it is assumed that the terminals 10, which are arranged along the vertical direction Y (which are held by the second outer wall portion 42 and the second inner wall portion 44), of the receptacle connector 2, and the terminals 60, which are arranged along the vertical direction Y (which are held by the second wall portion 92), of the plug connector 3 also have configurations similar to those of the terminals 10 and 50 described here.

As illustrated in FIG. 9, each of the terminals 10 of the receptacle connector 2 includes the mounting portion 11, the four leg portions 12, 14, 16, and 18, and the three coupling portions 13, 15, and 17 as described above.

In terms of the each of the terminals 10, a portion surrounded by the leg portion 16, the coupling portion 17, and the leg portion 18 is filled with resin (the first outer wall portion 41 of the housing 40) and is fixed. On the other hand, a portion surrounded by the leg portion 12, the coupling portion 13, and the leg portion 14 is filled with resin (the first inner wall portion 43 of the housing 40). However, the slit portions 43a extending in the mating direction Z are each formed between the adjacent terminals 10 in the first inner wall portion 43 (FIG. 1). Therefore, the portion surrounded by the leg portion 12, the coupling portion 13, and the leg portion 14 is designed to be elastically deformable toward the through-hole 2a in the horizontal direction X.

The leg portion 12, the coupling portion 13, and the leg portion 14 of the each of the terminals 10 form an “elastic portion” in the present disclosure. Furthermore, a space surrounded by the leg portions 14, the coupling portions 15, and the leg portions 16 of the terminals 10 forms the mating recessed portion 2b into which the terminals 50 of the plug connector 3 are fitted.

Next, each of the terminals 50 of the plug connector 3 includes the mounting portion 51, the two leg portions 52 and 54, the coupling portion 53 that couples the leg portions 52 and 54, and the extension portion 55 as described above. In terms of the each of the terminals 50, a portion surrounded by the leg portion 52, the coupling portion 53, and the leg portion 54 is filled with resin (the first wall portion 91 of the housing 90). The leg portions 52, the coupling portions 53, the leg portions 54, and the first wall portions 91 form the mating protruding portion 3b that is inserted into the above mating recessed portion 2b of the receptacle connector 2.

After the mating protruding portion 3b of the plug connector 3 is inserted into the mating recessed portion 2b of the receptacle connector 2, the terminals 50 forming the mating protruding portion 3b come into contact with the leg portions 14 and 16 of the terminals 10 forming the mating recessed portion 2b. At this point in time, the leg portion 12, the coupling portion 13, and the leg portion 14 (a portion corresponding to the above-mentioned “elastic portion”) of each of the terminals 10 are held by the first inner wall portion 43, which is formed with the slit portions 43a, of the housing 40 and therefore deform elastically toward the through-hole 2a in the horizontal direction X. On the other hand, the leg portion 16, the coupling portion 17, and the leg portion 18 are fixed by the first outer wall portion 41 of the housing 40 and therefore basically do not deform.

Next, the operations and effects of the above-mentioned first embodiment are described.

In the first embodiment, the receptacle connector 2 has a rectangular shape in plan view, and includes the housing 40 having the first outer wall portions 41, the second outer wall portions 42, the first inner wall portion 43, and the second inner wall portions 44, the groups of the terminals 10 held by the first outer wall portions 41 and the first inner wall portions 43, and the groups of the terminals 10 held by the second outer wall portions 42 and the second inner wall portions 44. The receptacle connector 2 is formed with the through-hole 2a extending in the mating direction Z, in the central portion surrounded by the first inner wall portions 43 and the second inner wall portions 44 of the housing 40. The mounting portions 11 of at least a part of the groups of the terminals 10 are placed on the through-hole 2a side.

Such a receptacle connector 2 according to the first embodiment has a rectangular shape in plan view. Therefore, the footprint of the receptacle connector 2 can be reduced. Moreover, the mounting portions 11 of the terminals 10 are placed on the through-hole 2a side. Therefore, the number of contacts of the terminals 10 provided to the receptacle connector 2 can be increased. For example, according to verification conducted by, for example, the inventor of the present disclosure, if the number of contacts up to approximately 30 is applied, when the terminals 10 are arranged on all the four sides of the rectangular shape as in the embodiment, the footprint of the connector tends to be able to be reduced as compared to a case where the terminals are arranged in two or four rows (particularly in a case of four-row arrangement).

Note that the operations and effects of the receptacle connector 2 are described above; however, the plug connector 3 can also obtain such operations and effects as those of the receptacle connector 2 described above since the plug connector 3 also has a configuration similar to that of the receptacle connector 2. The descriptions of the operations and effects of the plug connector 3 are omitted here to avoid redundant descriptions. Configurations, operations, and effects, which are common between the receptacle connector 2 and the plug connector 3, are also similarly described below, represented by the receptacle connector 2.

Next, in the first embodiment, in terms of each of the groups of the terminals 10, the mounting portions 11 of the adjacent terminals 10 are arranged alternately on the through-hole 2a side and on the side opposite to the through-hole 2a. Consequently, the mounting portions 11 aligned in a row can be located on the through-hole 2a side and on the side opposite to the through-hole 2a in a staggered formation. Therefore, it is possible to secure a distance between the adjacent mounting portions 11 and to appropriately solder each of the mounting portions 11. As a result, upon providing the groups of the terminals 10 to the receptacle connector 2, it is possible to reduce a distance between the adjacent terminals 10 and to further increase the number of contacts of the terminals 10 provided to the receptacle connector 2.

Moreover, in the first embodiment, the receptacle connector 2 includes the reinforcing metal fittings 30 that are formed in such a manner as to cover the corner portions 45 and 46 (the four corner portions 45 where the end portions of the first outer wall portions 41 and the second outer wall portions 42 are coupled, and the four corner portions 46 where the end portions of the first inner wall portions 43 and the second inner wall portions 44 are coupled) of the housing 40. Consequently, the reinforcing metal fittings 30 prevent the corner portions 45 and 46 of the housing 40 from being exposed. Therefore, it is possible to appropriately protect the corner portions 45 and 46 upon mating of the connectors 2 and 3.

Moreover, in the first embodiment, the plurality of terminals 10 each includes the elastic portion (the leg portion 12, the coupling portion 13, and the leg portion 14) that is configured in such a manner as to be elastically deformable upon mating and is placed on the through-hole 2a side. The first inner wall portions 43 and the second inner wall portions 44 of the housing 40 include the slit portions 43a and 44a that are formed in such a manner as to hold the elastic portions of the plurality of terminals 10 and are formed between the elastic portions of the adjacent terminals 10. Consequently, it is possible to appropriately displace the plurality of terminals 10 in the through-hole 2a upon mating.

Moreover, in the first embodiment, the group of the terminals 10 provided to the one of the pair of the wall portions each having the first outer wall portion 41 and the first inner wall portion 43 of the housing 40 and the group of the terminals 10 provided to the other of the pair face each other in the vertical direction Y and are symmetrically arranged. Hence, it is possible to simply configure the receptacle connector 2.

Moreover, in the first embodiment, the housing 40 (the receptacle connector 2) has an approximately square shape in plan view. Therefore, it is possible to well balance the achievement of a reduction in the footprint of the receptacle connector 2 and an increase in the number of contacts of the terminals 10.

### SECOND EMBODIMENT

Next, a second embodiment is described. Note that descriptions of configurations, operations, and effects, which are similar to those of the above first embodiment, are omitted here as appropriate. In other words, it is assumed that configurations, operations, and effects are similar to those of the first embodiment unless otherwise specified.

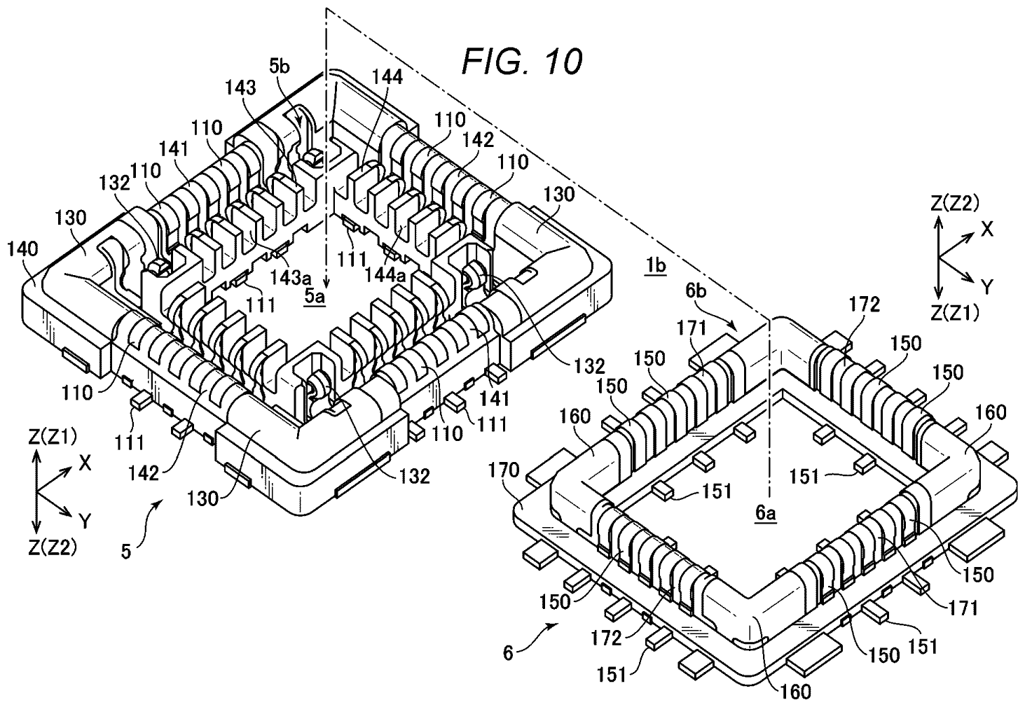

Firstly, the configuration of a connector assembly according to the second embodiment of the present disclosure is described with reference to FIG. 10. FIG. 10 is a perspective view of the connector assembly according to the second embodiment in an unmated state.

As illustrated in FIG. 10, a connector assembly 1b according to the second embodiment includes a receptacle connector 5 and a plug connector 6, and is configured in such a manner that the receptacle connector 5 and the plug connector 6 are mated together. When the receptacle connector 5 and the plug connector 6 are not distinguished below, they are denoted as the “connectors 5 and 6.” The connectors 5 and 6 are mounted on boards (not illustrated) such as printed wiring boards as mounted objects that are electrically connected together. FIG. 10 illustrates the connectors 5 and 6 both in a state where a mating side (mating surface) is placed on the front side and a side to be mounted on the board is placed on the back side. Moreover, the connectors 5 and 6 can be used as internal components of small electronic apparatuses such as mobile phones, smartphones, digital cameras, and notebook computers. Note that the connectors 5 and 6 are examples of the “electrical connector” of the present disclosure. These connectors 5 and 6 can be mounted on various mounted objects such as flexible flat cables, other than the above boards. However, an example where the connectors 5 and 6 are mounted on the boards is cited below.

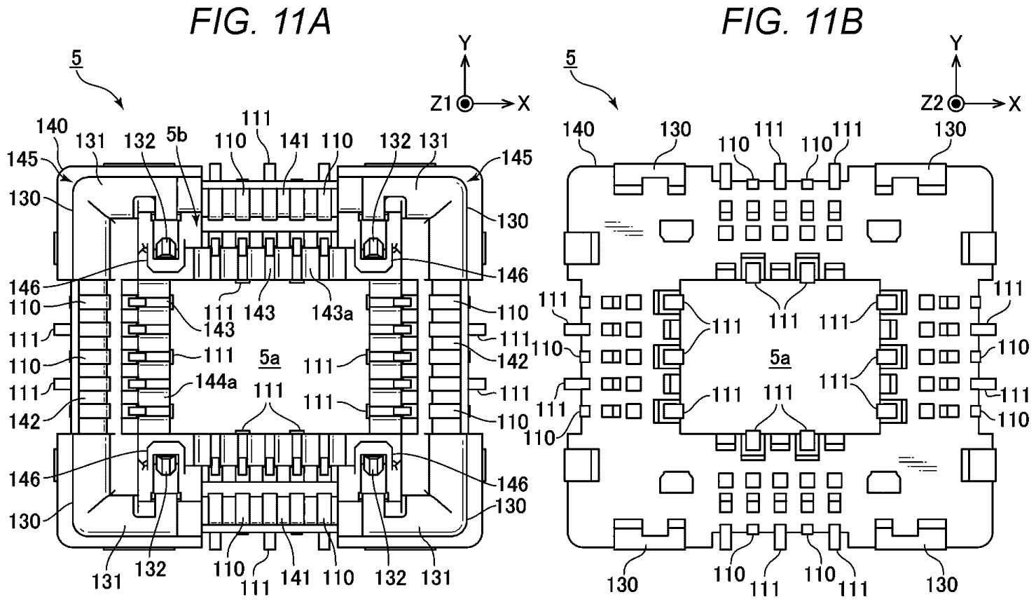

Next, the receptacle connector 5 according to the second embodiment is described also with reference to FIG. 11 in addition to FIG. 10. FIG. 11A is a plan view of the receptacle connector 5 as viewed from above (the front). FIG. 11B is a plan view of the receptacle connector 5 as viewed from below (the back).

As illustrated in FIGS. 10, 11A, and 11B, the receptacle connector 5 has a rectangular shape close to a square in plan view, and mainly includes a plurality of terminals 110 as signal terminals, reinforcing metal fittings 130, and a housing 140 that holds the terminals 110 and the reinforcing metal fittings 130. The terminals 110 and the reinforcing metal fittings 130 are formed of a conductive member such as a copper alloy, and the housing 140 is formed of resin such as liquid crystal polymer (LCP). The receptacle connector 5 is created by, for example, integral molding (typically insert molding), using such materials.

The housing 140 of the receptacle connector 5 has a rectangular shape in plan view, and includes four wall portions extending along four sides of the rectangular shape respectively. The four wall portions of the housing 140 include a pair of wall portions each having a first outer wall portion 141 and a second outer wall portion 142, and a pair of wall portions each having a first inner wall portion 143 and a second inner wall portion 144. The first inner wall portions 143 are provided inward of the first outer wall portions 141, and the second inner wall portions 144 are provided inward of the second outer wall portions 142.

In other words, the housing 140 includes a pair of the first outer wall portions 141 that extends in the horizontal direction X and is spaced apart in such a manner as to face each other in the vertical direction Y, a pair of the second outer wall portions 142 that extends in the vertical direction Y and is spaced apart in such a manner as to face each other in the horizontal direction X, a pair of the first inner wall portions 143 that is provided inward of the first outer wall portions 141, extends in the horizontal direction X, and is spaced apart in such a manner as to face each other in the vertical direction Y, and a pair of the second inner wall portions 144 that is provided inward of the second outer wall portions 142, extends in the vertical direction Y, and is spaced apart in such a manner as to face each other in the horizontal direction X.

Moreover, the housing 140 includes four corner portions 145 where end portions of the pair of the first outer wall portions 141 and the pair of the second outer wall portions 142 are coupled (FIG. 11A).

The receptacle connector 5 according to the embodiment is formed in a central portion thereof with a single through-hole 5a extending in the mating direction Z. The through-hole 5a is provided in a portion surrounded by the pair of the first inner wall portions 143 and the pair of the second inner wall portions 144 of the housing 140. The through-hole 5a has a rectangular shape in plan view. For example, a board component (for example, a chip capacitor) can be placed in the portion where the through-hole 5a of the receptacle connector 5 is.

The terminals 110 of the receptacle connector 5 are provided in groups along all the four sides of the rectangular housing 140. Specifically, the receptacle connector 5 includes groups of the terminals 110 that are held by the first outer wall portions 141 and the first inner wall portions 143 and extend in the vertical direction Y, and groups of the terminals 110 that are held by the second outer wall portions 142 and the second inner wall portions 144 and extend in the horizontal direction X.

The terminals 110 that are held by the first outer wall portions 141 and the first inner wall portions 143 and extend in the vertical direction Y are held at their one ends by the first outer wall portions 141, and at their other ends by the first inner wall portions 143. The group of the terminals 110 held by one of a pair of the wall portions each having the first outer wall portion 141 and the first inner wall portion 143 and the group of the terminals 110 held by the other of the pair face each other in the vertical direction Y and are symmetrically placed.

The terminals 110 that are held by the second outer wall portions 142 and the second inner wall portions 144 and extend in the horizontal direction X are held at their one ends by the second outer wall portions 142, and at their other ends by the second inner wall portions 144. The group of the terminals 110 held by one of a pair of the wall portions each having the second outer wall portion 142 and the second inner wall portion 144 and the group of the terminals 110 held by the other of the pair face each other in the horizontal direction X and are symmetrically placed.

Moreover, these terminals 110 each includes a mounting portion 111 for

mounting the receptacle connector 5 on the board by soldering. In the embodiment, the mounting portions 111 of a part of the groups of the terminals 110 are placed on a through-hole 5a side, and the mounting portions 111 of the rest of the groups of the terminals 110 are placed on a side opposite to the through-hole 5a (that is, placed in such a manner as to face outward of the receptacle connector 5). Specifically, the mounting portions 111 of adjacent terminals 110 of each of the groups of the terminals 110 arranged in a row along the horizontal direction X or the vertical direction Y are designed to be located alternately on the through-hole 5a side and on the side opposite to the through-hole 5a (FIGS. 11A and 11B).

In the receptacle connector 5, end portions on the through-hole 5a side of the groups of the terminals 110 are held by the first inner wall portions 143 and the second inner side wall portions 144 of the housing 140. The first inner wall portions 143 and the second inner wall portions 144 are formed with slit portions 143a and slit portions 144a, which extend in the mating direction Z, between the adjacent terminals 110, respectively. Consequently, the end portions of the terminals 110 held by the first inner wall portions 143 and the second inner wall portions 144 are designed to be elastically deformable toward the through-hole 5a.

Moreover, the receptacle connector 5 includes an approximately rectangular ring-shaped mating recessed portion 5b recessed in the mating direction Z. The mating recessed portion 5b is formed in portions between the first outer wall portions 141 and the first inner wall portions 143, which include the groups of the terminals 110, and portions between the second outer wall portions 142 and the second inner wall portions 144, which include the groups of the terminals 110. The plug connector 6 is formed with an approximately rectangular ring-shaped mating protruding portion 6b protruding in the mating direction Z. The mating protruding portion 6b of the plug connector 6 is designed to fit into the mating recessed portion 5b of the receptable connector 5 (FIG. 10).

Furthermore, the receptacle connector 5 is provided with the reinforcing metal fittings 130. The reinforcing metal fittings 130 are provided to the four corner portions 145 of the housing 140 in such a manner as to cover the corner portions 145, respectively (FIG. 11A). The reinforcing metal fittings 130 each include an L-shaped reinforcing portion 131 that is formed in such a manner as to cover the corner portion 145, and a terminal 132 as a power terminal coupled to the reinforcing portion 131.

The terminals 132 of the reinforcing metal fittings 130 are configured in such a manner as to be elastically deformable in the vertical direction Y upon mating of the receptacle connector 5 and the plug connector 6. More specifically, the terminals 132 are designed to be capable of being displaced in the vertical direction Y in recessed portions 146 formed in portions where the first inner wall portions 143 and the second inner wall portions 144 of the housing 140 are coupled, respectively.

In the receptacle connector 2 according to the above first embodiment, the terminals 20 as the power terminals having a configuration similar (analogous) to that of the terminals 10 are each provided between the terminals 10 as the signal terminals (FIGS. 1 and 2A). On the other hand, the receptacle connector 5 according to the second embodiment is not provided with power terminals having a configuration similar (analogous) to that of the terminals 110, and the reinforcing metal fittings 130 each includes the terminal 132 as the power terminal. Note that the terminals 132 are not limited to being configured as the power terminals, and may be configured as ground terminals.

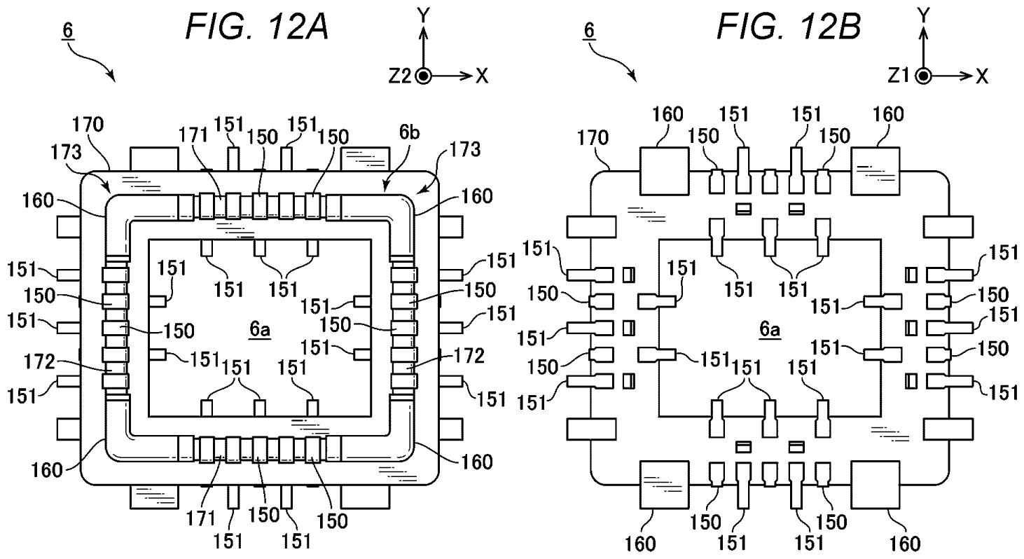

Next, the plug connector 6 according to the second embodiment is described also with reference to FIGS. 12A to 12B in addition to FIG. 10. FIG. 12A is a plan view of the plug connector 6 as viewed from above (the front). FIG. 12B is a plan view of the plug connector 6 as viewed from below (the back).

As illustrated in FIGS. 10, 12A, and 12B, the plug connector 6 has a rectangular shape close to a square in plan view, and mainly includes a plurality of terminals 150 as signal terminals, reinforcing metal fittings 160, and a housing 170 that holds the terminals 150 and the reinforcing metal fittings 160. The terminals 150 and the reinforcing metal fittings 160 are formed of a conductive member such as a copper alloy, and the housing 170 is formed of resin such as liquid crystal polymer (LCP). The plug connector 6 is created by, for example, integral molding (typically insert molding), using such materials.

The housing 170 of the plug connector 6 has a rectangular shape in plan view, and includes four wall portions extending along four sides of the rectangular shape respectively. The four wall portions of the housing 170 include a pair of first wall portions 171 and a pair of second wall portions 172.

In other words, the housing 170 includes the pair of first wall portions 171 that extends in the horizontal direction X, and is spaced apart in such a manner as to face each other in the vertical direction Y, and the pair of second wall portions 172 that extends in the vertical direction Y and is spaced apart in such a manner as to face each other in the horizontal direction X. Moreover, the housing 170 includes four corner portions 173 where end portions of the pair of first wall portions 171 and the pair of second wall portions 172 are coupled (FIG. 12A).

The plug connector 6 according to the embodiment is formed in a central portion thereof with a single through-hole 6a extending in the mating direction Z. The through-hole 6a is provided in a portion surrounded by the pair of first wall portions 171 and the pair of second wall portions 172 of the housing 170. The through-hole 6a has a rectangular shape in plan view. For example, a board component (for example, a chip capacitor) can be placed in the portion where the through-hole 6a of the plug connector 6 is.

The terminals 150 of the plug connector 6 are provided in groups along all the four sides of the rectangular housing 170. Specifically, the plug connector 6 includes groups of the terminals 150 that are held by the first wall portions 171 and extend in the vertical direction Y, and groups of the terminals 150 that are held by the second wall portions 172 and extend in the horizontal direction X.

The group of the terminals 150 held by one of the pair of first wall portions 171 and the group of the terminals 150 held by the other of the pair face each other in the vertical direction Y and are symmetrically placed.

The group of the terminals 150 held by one of the pair of second wall portions 172 and the group of the terminals 150 held by the other of the pair face each other in the horizontal direction X and are symmetrically placed.

Moreover, these terminals 150 each includes a mounting portion 151 for mounting the receptacle connector 6 on the board by soldering. In the embodiment, the mounting portions 151 of a part of the groups of the terminals 150 are placed on a through-hole 6a side, and the mounting portions 151 of the rest of the groups of the terminals 150 are placed on a side opposite to the through-hole 6a (that is, placed in such a manner as to face outward of the receptacle connector 6). Specifically, the mounting portions 151 of adjacent terminals 150 of each of the groups of the terminals 150 arranged in a row along the horizontal direction X or the vertical direction Y are designed to be located alternately on the through-hole 6a side and on the side opposite to the through-hole 6a (FIGS. 12A and 12B).

Furthermore, the four corner portions 173 of the above housing 170 of the plug connector 6 are provided with the L-shaped reinforcing metal fittings 160 that are formed in such a manner as to cover the corner portions 173, respectively (FIG. 12A). The reinforcing metal fittings 160 are designed to function as power terminals by being electrically connected to the terminals 132 of the reinforcing metal fittings 130 of the above receptacle connector 5 upon mating of the receptacle connector 5 and the plug connector 6.

The plug connector 3 according to the above first embodiment is provided with the terminals 70 as the power terminals having a configuration similar (analogous) to that of the terminals 50 as the signal terminals each between the terminals 50 (FIGS. 1 and 5A). On the other hand, the plug connector 6 according to the second embodiment is not provided with power terminals having a configuration similar (analogous) to that of the terminals 150, and the reinforcing metal fittings 160 function as the power terminals. Note that the reinforcing metal fittings 160 are not limited to functioning as the power terminals, and may function as ground terminals.

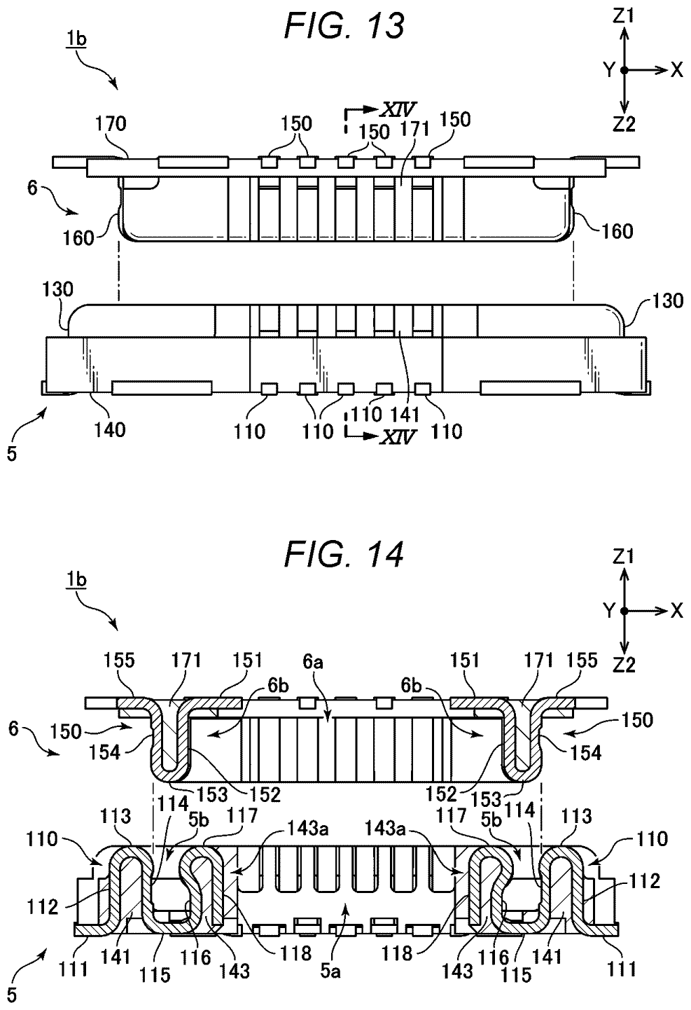

Next, the configurations of the terminals of the receptacle connector 5 and the plug connector 6 according to the second embodiment are described with reference to FIGS. 13 and 14. FIG. 13 is a side view of the connector assembly 1b according to the second embodiment before mating as viewed along the vertical direction Y. FIG. 14 is a cross-sectional view of the connector assembly 1b according to the second embodiment as viewed along line XIV-XIV of FIG. 13.

Note that a description is given, taking, as an example, the configurations of the terminals 110, which are arranged along the horizontal direction X (which are held by the first outer wall portion 141 and the first inner wall portion 143), of the receptacle connector 5, and the terminals 150, which are arranged along the horizontal direction X (which are held by the first wall portion 171), of the plug connector 6. However, it is assumed that the terminals 110, which are arranged along the vertical direction Y (which are held by the second outer wall portion 142 and the second inner wall portion 144), of the receptacle connector 5, and the terminals 150, which are arranged along the vertical direction Y (which are held by the second wall portion 172), of the plug connector 6 also have configurations similar to those of the terminals 110 and 150 described here. As illustrated in FIG. 14, each of the terminals 110 of the receptacle connector 5 includes leg portions 112, 114, 116, and 118, the mounting portion 111, and coupling portions 113, 115, and 117. The leg portions 112, 114, 116, and 118 extend in the mating direction Z, and are provided in this order along the horizontal direction X, spaced apart from one another. The mounting portion 111 is connected to one end of the leg portion 112.

The coupling portion 113 extends in the horizontal direction X, and connects an end portion of the leg portion 112 and an end portion of the leg portion 114. The coupling portion 115 extends in the horizontal direction X, and connects an end portion of the leg portion 114 and an end portion of the leg portion 116. The coupling portion 117 extends in the horizontal direction X, and connects an end portion of the leg portion 116 and an end portion of the leg portion 118.

In terms of the each of the terminals 110, a portion surrounded by the leg portion 112, the coupling portion 113, and the leg portion 114 is filled with resin (the first outer wall portion 141 of the housing 140) and is fixed. On the other hand, a portion surrounded by the leg portion 116, the coupling portion 117, and the leg portion 118 is filled with resin (the first inner wall portion 143 of the housing 140). However, slit portions 143a extending in the mating direction Z are each formed between the adjacent terminals 110 of the first inner wall portion 143 (FIG. 10). Therefore, the portion surrounded by the leg portion 116, the coupling portion 117, and the leg portion 118 is designed to be elastically deformable toward the through-hole 5a in the horizontal direction X.

The leg portion 116, the coupling portion 117, and the leg portion 118 of the each of the terminals 110 form the “elastic portion” in the present disclosure. Furthermore, a space surrounded by the leg portions 114, the coupling portions 115, and the leg portions 116 of the terminals 110 forms the mating recessed portion 5b into which the terminals 150 of the plug connector 6 are fitted.

Next, each of the terminals 150 of the plug connector 6 includes leg portions 152 and 154, the mounting portion 151, a coupling portion 153, and an extension portion 155. The leg portions 152 and 154 extend in the mating direction Z, and are provided along the horizontal direction X, spaced apart from each other. The mounting portion 151 is connected to one end of the leg portion 152. The coupling portion 153 extends in the horizontal direction X, and connects an end portion of the leg portion 152 and an end portion of the leg portion 154. The extension portion 155 is connected to one end of the leg portion 154.

In terms of the each of the terminals 150, a portion surrounded by the leg portion 152, the coupling portion 153, and the leg portion 154 is filled with resin (the first wall portion 171 of the housing 170). The leg portions 152, the coupling portions 153, the leg portions 154, and the first wall portions 171 form the mating protruding portion 6b that is inserted into the above mating recessed portion 5b of the receptacle connector 5.

After the mating protruding portion 6b of the plug connector 6 is inserted into the mating recessed portion 5b of the receptacle connector 5, the terminals 150 forming the mating protruding portion 6b come into contact with the leg portions 114 and 116 of the terminals 110 forming the mating recessed portion 5b. At this point in time, the leg portion 116, the coupling portion 117, and the leg portion 118 (a portion corresponding to the above-mentioned “elastic portion”) of each of the terminals 110 are held by the first inner wall portion 143, which is formed with the slit portions 143a, of the housing 140 and therefore deform elastically toward the through-hole 5a in the horizontal direction X. On the other hand, the leg portion 112, the coupling portion 113, and the leg portion 114 are fixed by the first outer wall portion 141 of the housing 140 and therefore basically do not deform.

The receptacle connector 5 according to the second embodiment has a rectangular shape in plan view, and includes the housing 140 having the first outer wall portions 141, the second outer wall portions 142, the first inner wall portions 143, and the second inner wall portions 144, the groups of the terminals 110 held by the first outer wall portions 141 and the first inner wall portions 143, and the groups of the terminals 110 held by the second outer wall portions 142 and the second inner wall portions 144. The receptacle connector 5 is formed with the through-hole 5a extending in the mating direction Z, in the central portion surrounded by the first inner wall portions 143 and the second inner wall portions 144 of the housing 140. The mounting portions 111 of at least a part of the groups of the terminals 110 are placed on the through-hole 5a side. The plug connector 6 according to the second embodiment also has a configuration similar to that of such a receptacle connector 5. Therefore, the second embodiment also enables a reduction in the footprints of the connectors and an increase in the number of contacts of the terminals.

### Modifications

The above-mentioned first and second embodiments are exemplifications for describing the present disclosure, and the present disclosure is not limited to the first and second embodiments. The present disclosure can be carried out in various forms without departing from a gist thereof.

The electronic connector and the connector assembly according to the present disclosure can be used for purposes such as connections between boards with a flat cable in electronic apparatuses such as smartphones and mobile phones that can transmit electric signals at high speeds.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electrical connector comprising:
a housing;
a plurality of terminals; and
a through-hole, wherein
the housing has a rectangular shape in plan view, and includes four wall portions extending along four sides of the rectangular shape respectively,
the plurality of terminals is held by all the four wall portions,
the through-hole is provided in a portion surrounded by the four wall portions of the housing in such a manner as to extend in a direction of mating to a mating connector,
each of the plurality of terminals includes a mounting portion configured to be mounted on a mounted object, and
the mounting portions of a part of the plurality of terminals is placed on a through-hole side.

2. The electrical connector according to claim 1, wherein the mounting portions of adjacent terminals of the plurality of terminals are arranged in such a manner as to be located alternately on the through-hole side and on a side opposite to the through-hole.

3. The electrical connector according to claim 1, further comprising reinforcing metal fittings, wherein the reinforcing metal fittings are provided in such a manner as to cover corner portions where end portions of the four wall portions of the housing are coupled.

4. The electrical connector according to claim 3, wherein
the plurality of terminals is signal terminals, and
the electrical connector further includes power terminals or ground terminals that are coupled to the reinforcing metal fittings.

5. The electrical connector according to claim 1, wherein
each of the plurality of terminals includes an elastic portion,
each of the four wall portions of the housing includes a plurality of slit portions,
the elastic portions are placed on the through-hole side and are configured to be elastically deformable upon mating of the electrical connector to the mating connector, and
each of the plurality of slit portions is provided between the elastic portions of adjacent terminals of the plurality of terminals.

6. The electrical connector according to claim 1, wherein a group of the terminals provided to one of a pair of opposing wall portions of the four wall portions and a group of the terminals provided to the other of the pair face each other and are symmetrically arranged.

7. The electrical connector according to claim 1, where the housing has an approximately square shape in plan view.

8. The electrical connector according to claim 1, wherein the plurality of terminals includes signal terminals, and at least one of a power terminal or a ground terminal.

9. A connector assembly comprising:
a first connector; and
a second connector configured to be capable of mating to the first connector, wherein
the first connector includes a first housing, a plurality of first terminals, and a first through-hole,
the first housing has a rectangular shape in plan view, and includes four first wall portions extending along four sides of the rectangular shape respectively,
the plurality of first terminals is held by all the four first wall portions,
the first through-hole is provided in a portion surrounded by the four first wall portions of the first housing in such a manner as to extend in a direction of mating to the second connector,
the second connector includes a second housing, a plurality of second terminals, and a second through-hole,
the second housing has a rectangular shape in plan view, and includes four second wall portions extending along four sides of the rectangular shape respectively,
the plurality of second terminals is held by all the four second wall portions, and is configured to be electrically connectable to the plurality of first terminals of the first connector respectively, and
the second through-hole is provided in a portion surrounded by the four second wall portions of the second housing in such a manner as to extend in a direction of mating to the first connector.

10. The connector assembly according to claim 9, wherein
each of the plurality of first terminals includes a mounting portion to be mounted on a mounted object, and
the mounting portions of at least a part of the plurality of first terminals are placed on a first through-hole side.

11. The connector assembly according to claim 10, wherein the mounting portions of adjacent first terminals of the plurality of first terminals are arranged in such a manner as to be located alternately on the first through-hole side and a side opposite to the first through-hole.
